(19) United States
(12) Patent Application Publication
(10) Pub. No.: US 2020/0206986 A1
(43) Pub. Date: Jul. 2, 2020

(54) DOUBLE COMPRESSION MOLDING MACHINE AND MANUFACTURING METHOD OF PRODUCT

(71) Applicants: MAHLE International GmbH, Stuttgart (DE); MAHLE Filter Systems Japan Corporation, Tokyo (JP)

(72) Inventors: Kosei Imafuku, Tokyo (JP); Teruo Wakabayashi, Tokyo (JP)

(21) Appl. No.: 16/729,387

(22) Filed: Dec. 28, 2019

(30) Foreign Application Priority Data
Dec. 28, 2018 (JP) 2018-248492

(51) Int. Cl. B29C 43/34; B29C 43/36; B29C 43/52

(52) U.S. Cl. CPC B29C 43/34; B29C 43/361; B29C 2043/3444; B29C 2043/3615; B29C 2043/3678; B29C 43/52

(57) ABSTRACT

In a double compression molding machine, a supporting member supports an internal part to be sealed in an inner portion of a product to be molded. A mold includes a cavity in which the product is to be molded, a cylinder hole which communicates with the cavity and into which a plunger is inserted, an insertion hole which communicates with the cavity and into which a supporting member is inserted and a fixing member which fixes the internal part in the cavity. A plunger driving apparatus presses a resin material inserted in the cylinder hole in the cavity such that the product is molded by advancing the plunger from a retracted position toward the cavity. A supporting member driving apparatus presses the supporting member until the supporting member abuts on the internal part fixed in the cavity, and extracts the supporting member from the cavity.

### CROSS REFERENCE TO RELATED APPLICATIONS

This application claims priority to Japanese patent application JP 2018 248492, filed Dec. 28, 2018, the entire content of which is incorporated herein by reference.

### TECHNICAL FIELD

The present disclosure relates to a double compression molding machine and a manufacturing method of a product, and in particular, to a double compression molding machine for molding a product in which an internal part is sealed in an inner portion and a manufacturing method of the product in which the internal part is sealed in the inner portion.

### BACKGROUND

To protect internal parts such as a sensor etc., integrally molding an internal part in a resin to seal the internal part has been widely executed. As such technology, for example, a resin sealing method of holding an electronic part by a resin material molded to be not completely cured, disposing this in an inner space of a mold, and further, allowing a resin material of the similar material to flow into the inner space for covering has been known (for example, from JP 2015-32654). This document describes a method of resin sealing of an electronic part in which, even when a terminal lead is included, holding and hanging the terminal lead is unnecessary

However, in the above method, before flowing of the resin for manufacturing the product, a step of holding the electronic part by the similar resin is necessary. Also, when this is achieved by transfer molding, a primary molding process of previously fixing a part by curable resin is necessary, so that reduction of a manufacturing time is difficult. Further, inhibiting a cost of a transfer molding machine and improvement of yield of a material are also difficult.

### SUMMARY

It is an object of the present disclosure to reduce the manufacturing time of the product in which the internal part is sealed and to inhibit the manufacturing cost.

In accordance with an aspect of the present disclosure, there is provided a double compression molding machine including a plunger, a supporting member which supports an internal part to be sealed in an inner portion of a product to be molded, a mold having a cavity in which the product is molded, a cylinder hole which communicates with the cavity and into which the plunger is inserted, an insertion hole which communicates with the cavity and into which the supporting member is inserted, and a fixing member which fixes the internal part in the cavity, a plunger driving apparatus which presses a resin material inserted in the cylinder hole into the cavity such that the product is molded when the plunger is at a retracted position by advancing the plunger inserted in the cylinder hole from the retracted position toward the cavity, and a supporting member driving apparatus which presses the supporting member inserted in the insertion hole until the supporting member abuts on the internal part fixed in the cavity and extracts the supporting member inserted in the insertion hole from the cavity.

According to this aspect of the disclosure, the internal part can be directly sealed by the resin material to mold the product. Consequently, division of the configuration such as a primary molding and a secondary molding is unnecessary, and thus a manufacturing time is reduced and a manufacturing cost is inhibited.

A heating apparatus which heats the resin material inserted in the cylinder hole may be further included. According to this aspect of the disclosure, a solid resin material can be inserted into the cylinder hole to mold the product. Consequently, a trouble of melting the resin material before it is inserted into the cylinder hole can be omitted.

In accordance with an aspect of the present disclosure, there is provided a manufacturing method, including the steps of inserting a resin material in a cylinder hole when a plunger which is inserted is at a retracted position, fixing an internal part to be sealed in an inner portion of the product to be molded in a cavity of a mold where the product is to be molded, pressing a supporting member inserted in an insertion hole, the insertion hole communicating with the cavity, until the supporting member abuts on the internal part fixed in the cavity by the supporting member driving apparatus, and pressing the resin material inserted in the cylinder hole in the cavity such that the product is molded by advancing the plunger inserted in the cylinder hole, the cylinder hole communicating with the cavity, from the retracted position toward the cavity, wherein in the pressing step of the resin material in the cavity, the supporting member is extracted from the cavity.

Also, according to this aspect of the disclosure, the internal part can be directly sealed by the resin material to mold the product. Consequently, division of the configuration such as the primary molding and the secondary molding is unnecessary, and thus the manufacturing time is reduced, and the manufacturing cost is inhibited.

The pressing step of the resin material in the cavity includes a first pressure step of pressing the resin material in the cavity with a primary pressure, and a second pressure step of pressing the resin material in the cavity with a secondary pressure which is higher than the primary pressure, wherein in the second pressure step, the supporting member may be extracted from the cavity.

In accordance with this aspect of the disclosure, firstly, the resin material is spread to the entire cavity in the first pressure step and curing of the resin material can be promoted in the second pressure step. Consequently, in the second pressure step, the internal part is difficult to move by the resin material, and by extracting the supporting member from the cavity in the second pressure step, a positional variation of the internal part can be inhibited. Further, since the resin material is not completely cured during the second pressure step, even when the supporting member is extracted from the cavity, the resin material can be filled into a portion where the supporting member had been.

In accordance to an aspect of the present disclosure, the internal part can be directly sealed by the resin material to mold the product. Accordingly, the manufacturing time can be reduced, and the manufacturing cost can be inhibited.

### BRIEF DESCRIPTION OF THE DRAWINGS

The disclosure will now be described with reference to the drawings wherein:

FIG. 1 shows a configuration of a double compression molding machine according to an exemplary embodiment of the present disclosure;

FIG. 2 shows an insertion step of a resin material;

FIG. 3 shows an attachment step of an internal part to a lower mold;

FIG. 4 shows a state in which the lower mold is moved to a portion below an upper mold after insertion of the resin material and attachment of the internal part to the lower mold;

FIG. 5 shows a closing step of a mold;

FIG. 6 shows an advancing step of a supporting member;

FIG. 7 shows a first pressure step;

FIG. 8 shows a second pressure step;

FIG. 9 shows an extracting step of the supporting member;

FIG. 10 shows an opening step of the mold after molding of a product;

FIG. 11 shows a removing step of the product;

FIG. 12A is a front view of the internal part;

FIG. 12B is a side view of the internal part;

FIG. 13A is a front view of the product, and

FIG. 13B is a side view of the product.

### DESCRIPTION OF EXEMPLARY EMBODIMENTS

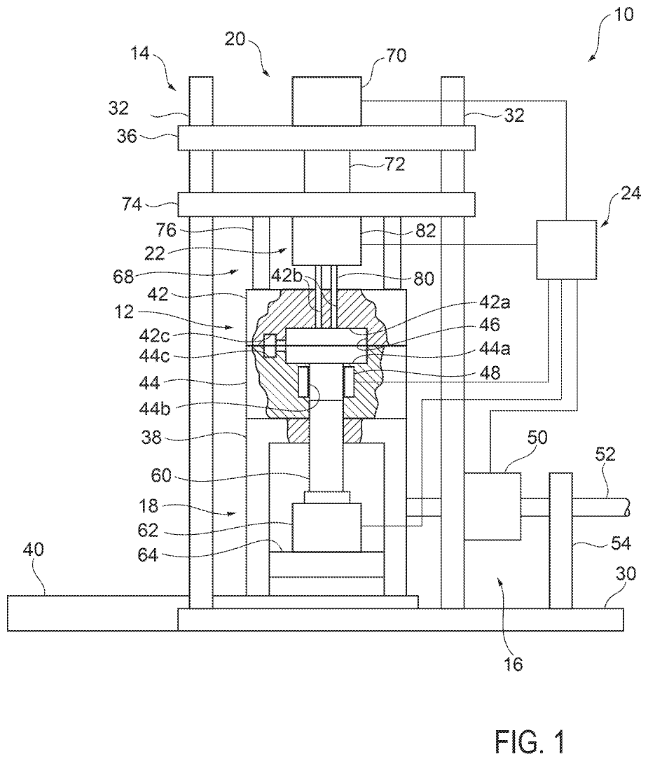

FIG. 1 shows a configuration of a double compression molding machine according to an exemplary embodiment of the present disclosure. The double compression molding machine 10 includes a mold 12, a housing 14, a mold moving unit 16, a plunger driving unit 18, an upper mold lifting apparatus 20, a supporting member driving unit 22 and a control unit 24.

The housing 14 includes a base plate 30, four struts 32, a top plate 36, a lower mold supporting member 38 and a base guide 40. The base plate 30 is a plate-like member mounted on a horizontal ground. The base plate 30 is formed with a large recessed part at the center such that the base guide 40 can be arranged at the center. The four struts 32 are cylindrical members each of which are fixed to perpendicularly extend from the base plate 30. The four struts 32 are arranged such that the center of each strut is positioned at rectangular corners seen from the above. The top plate 36 is a plate-like rectangular member formed with holes allowing the four struts 32 to pass at a periphery of its four corners. The four struts 32 fixed to the base plate 30 are inserted into these holes, whereby the top plate 36 is fixed adjacent to an upper end of the struts 32 in a horizontal state.

The lower mold supporting member 38 is a stand provided with a hollow space at a lower portion. The lower mold supporting member 38 has a horizontal upper surface, and a lower mold 44 is disposed to be fixed on the upper surface. The base guide 40 is a plate-like member disposed on the horizontal ground, and the lower mold supporting member 38 is disposed on the base guide 40. To the base guide 40, a guide portion for guiding linear moving of the lower mold supporting member 38 in a horizontal direction is provided.

The mold 12 includes an upper mold 42 and a lower mold 44. Both the upper mold 42 and the lower mold 44 are rectangular parallelepiped solid members made of steel. Additionally, the mold 12 may be made of a plurality of molds arranged transversely, for example, not two molds arranged in the up-down direction according to an exemplary embodiment of the present disclosure.

In the upper mold 42, an upper cavity 42a, an insertion hole 42b and a fixing member supporting hole 42c are formed. The upper cavity 42a is formed to be recessed upwardly from a lower surface of the upper mold 42. The upper cavity 42a is shaped as an upper half of a contour of a product to be molded.

The insertion hole 42b is a hole into which a supporting member which will be described later is inserted. In the exemplary embodiment, the insertion hole 42b penetrates through the upper cavity 42a vertically downward from an upper surface of the upper mold 42. Also, in the exemplary embodiment, two insertion holes 42b are formed at the upper mold 42. Additionally, needless to say, the number of the insertion holes 42b and a location of the insertion holes 42b are not limited to this. For example, three or more of insertion holes 42b may be provided at the upper mold 42. In addition, an insertion hole penetrating through the upper cavity 42a in the horizontal direction may be formed from a lateral side of the upper mold 42.

The fixing member supporting hole 42c is a hole into which a fixing member, which will be described later, is inserted for supporting in order to fix an internal part to be sealed in an inner portion of the product to be molded. The fixing member supporting hole 42c is a bottomed hole recessed upward from the lower surface of the upper mold 42. The fixing member supporting hole 42c is formed to be adjacent to the upper cavity 42a.

In the lower mold 44, a lower cavity 44a, a cylinder hole 44b and a fixing member supporting hole 44c are formed. The lower cavity 44a is formed to be recessed downwardly from an upper surface of the lower mold 44. The lower cavity 44a is shaped as a lower half of the contour of the product to be molded.

The cylinder hole 44b is a hole into which a plunger, which will be described later, is inserted. The cylinder hole 44b communicates with the lower cavity 44a vertically upward from a lower surface of the lower mold 44.

The fixing member supporting hole 44c is a hole into which the above-described fixing member is inserted for supporting. The fixing member supporting hole 44c is a bottomed hole recessed downward from the upper surface of the lower mold 44. The fixing member supporting hole 44c is formed to be adjacent to the lower cavity 44a.

When the mold 12 is closed, that is, when the lower surface of the upper mold 42 abuts on the upper surface of the lower mold 44, an integrated cavity 46 is formed by the upper cavity 42a of the upper mold 42 and the lower cavity 44a of the lower mold 44. The cavity 46 has an inner surface corresponding to the contour of the product to be molded, and the product is molded in this cavity 46. Also, when the mold 12 is closed, the fixing member which will be described later is grasped by the fixing member supporting hole 42c of the upper mold 42 and the fixing member supporting hole 44c of the lower mold 44 for fixing. Consequently, the fixing member supporting hole 42c and the fixing member supporting hole 44c function as a fixing portion for fixing the internal part in the cavity 46.

A heater 48, which is a heating apparatus, is built into an inner portion at a periphery of the cylinder hole 44b of the lower mold 44. The heater 48 heats a resin material inserted in the cylinder hole 44b for melting.

The mold moving unit 16 is a mechanism for moving the lower mold 44 in the horizontal direction. The mold moving unit 16 includes a mold moving apparatus 50, a ball screw 52 and a guide plate 54. One end of the ball screw 52 is attached to the lower mold supporting member 38 rotatably and immovably in an axial direction of the ball screw 52. The guide plate 54 extends to vertically stand from the base plate 30. A hole for supporting the ball screw 52 rotatably is provided at the guide plate 54. The guide plate 54 supports the ball screw 52 rotatably such that the ball screw 52 extends in the horizontal direction. The mold moving apparatus 50 is provided with an electric motor (not shown) and a transmission mechanism (not shown), and due to their operation, the ball screw 52 is moved in the horizontal direction and the lower mold 44 is moved with the lower mold supporting member 38 in the horizontal direction.

The plunger driving unit 18 includes a plunger 60, a plunger driving apparatus 62, and a supporting plate 64. The plate-like supporting plate 64 extending in the horizontal direction is fixed at a hollow portion of the lower mold supporting member 38. The plunger driving apparatus 62 is arranged on the supporting plate 64. The plunger driving apparatus 62 is attached to a lower end of the plunger 60. The plunger 60 is formed to be columnar. In the lower mold supporting member 38, an opening allowing the plunger 60 to pass is provided at an upper surface. The plunger 60 passes through the opening to be inserted in the cylinder hole 44b of the lower mold 44. The plunger driving apparatus 62 is a hydraulic actuator, and due to its operation, the plunger 60 is moved in the up-down direction in the cylinder hole 44b of the lower mold 44. Additionally, the plunger driving apparatus 62 may be another actuator such as an electric motor.

The upper mold lifting apparatus 20 uplifts and lowers the upper mold 42. The upper mold lifting apparatus 20 includes an upper mold lifting apparatus 70 and a transmission portion 72. To the double compression molding machine 10, an upper mold unit 68 is further provided. The upper mold unit 68 is formed by the upper mold 42, an intermediate plate 74, and a mold fixing member 76. The intermediate plate 74 is formed as a plate-like rectangular member in the similar manner as the top plate 36. Also, to the intermediate plate 74, holes allowing the four struts 32 to pass are formed at the periphery of its four corners. The four struts 32 fixed to the base plate 30 are inserted into these holes, whereby the intermediate plate 74 is arranged between the top plate 36 and the upper mold 42 in a horizontal state to be movable in the up-down direction.

The mold fixing member 76 is a rod-like member, and in the exemplary embodiment, four mold fixing members 76 are interposed between the intermediate plate 74 and the upper mold 42 to extend in a vertical direction for fixing these components.

The upper mold lifting apparatus 70 is fixed on an upper surface of the top plate 36. The transmission portion 72 has an upper end fixed to a lower surface of the top plate 36 and a lower end fixed to an upper surface of the intermediate plate 74. The upper mold lifting apparatus 70 is a hydraulic actuator, and due to its operation, the transmission portion 72 is contracted, the upper mold unit 68 is uplifted and lowered and the upper mold 42 is uplifted and lowered. Additionally, the upper mold lifting apparatus 70 may be another actuator such as an electric motor.

The supporting member driving unit 22 includes a supporting member 80 and a supporting member driving apparatus 82. The supporting member 80 is a member which supports the internal part to be sealed in the inner portion of the product to be molded in the cavity 46. In the exemplary embodiment, the supporting member 80 is formed as two pins. Additionally, the number or the shape of supporting members 80 is obviously not limited to this. The supporting member 80 is inserted into the insertion hole 42b of the upper mold 42 movably in the up-down direction. The supporting member driving apparatus 82 has an upper end fixed to the intermediate plate 74. The upper end of the supporting member 80 is attached to the supporting member driving apparatus 82. The supporting member driving apparatus 82 is also a hydraulic actuator, and due to its operation, the supporting member 80 is moved in the up-down direction. Additionally, the supporting member driving apparatus 82 may be another actuator such as an electric motor.

The control unit 24 is a control unit for controlling the double compression molding machine 10 and includes hardware such as a CPU (central processing unit), a memory and a storage unit, and software stored in the storage unit, and functions as a computer. The control unit 24 controls an operation of the double compression molding machine 10 by cooperation of the hardware and the software. More specifically, the control unit 24 is connected to the heater 48, the mold moving apparatus 50, the plunger driving apparatus 62, the upper mold lifting apparatus 70 and the supporting member driving apparatus 82 and controls the operation or on/off of these components.

The control unit 24 includes an input device (not shown) and an output device (not shown). The input device includes a keyboard or buttons etc. A user can input information for operating the double compression molding machine 10 to the control unit 24 using this input device. The control unit 24 controls the double compression molding machine 10 in accordance with the inputted information. The output device includes a display. The output device displays information inputted by the user or information showing an operation state of the double compression molding machine 10.

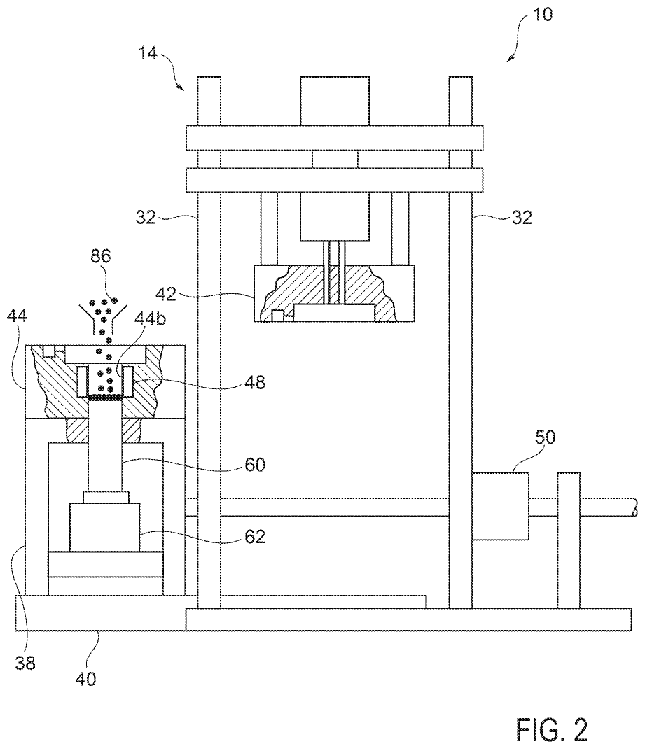

FIGS. 2 to 9 show a manufacturing step of the product by the double compression molding machine 10. Hereinafter, to avoid complication in the drawings, the control unit 24 and a line connecting the control unit 24 and an object to be controlled are omitted.

FIG. 2 shows an insertion step of a resin material 86. In a state that the upper mold 42 is uplifted, the control unit 24 operates the mold moving apparatus 50 to move the lower mold supporting member 38 and the lower mold 44 fixed on the lower mold supporting member 38 in the horizontal direction on the base guide 40. The control unit 24 operates the mold moving apparatus 50 until the lower mold 44 is positioned outside of the struts 32. Due to this, a portion above the lower mold 44 becomes an open space, which makes insertion of the resin material 86 easy.

In the exemplary embodiment, as the resin material 86, thermoset resin is used. As a result of research and development by the inventors, it is confirmed that thermoset resin, especially thermoset epoxy resin is most suitable for a manufacturing method of the product.

The control unit 24 operates the plunger 60 to previously move the plunger 60 to a lower retracted position to allow inserting the resin material 86 into the cylinder hole 44b. The resin material 86 is inserted into the cylinder hole 44b with the plunger 60 in the retracted position. In this way, the cylinder hole 44b functions not only as guiding movement of the plunger 60 but also as a pot in which the inserted resin material 86 is housed, that is, an accommodating part. While an operator inserts the resin material 86 in the cylinder hole 44b in the exemplary embodiment, a material inserting apparatus which automatically inserts a predetermined amount of resin material 86 in the cylinder hole 44b may be used.

The control unit 24 maintains on-state of the heater 48 when the plunger 60 is at the retracted position such that the resin material 86 in the cylinder hole 44b is heated. Consequently, the resin material 86 inserted in the cylinder hole 44b starts melting immediately after it is inserted. Additionally, in the exemplary embodiment, a solid powder resin material 86 is inserted in the cylinder hole 44b. However, a solid pellet resin material 86 may be inserted in the cylinder hole 44b, or a melted or partially melted resin material 86 may be inserted in the cylinder hole 44b.

The control unit 24 controls on/off of the heater 48 such that an inner portion of the cylinder hole 44b is maintained at a predetermined temperature required for melting of the resin material 86. In the exemplary embodiment, the control unit 24 controls on/off of the heater 48 such that the inner portion of the cylinder hole 44b is 170° C. To achieve this, a temperature sensor may be provided to the lower mold 44, and a detection result of the temperature sensor may be outputted to the control unit 24. Additionally, the temperature of the cylinder hole 44b to be maintained is not limited to 170° C.

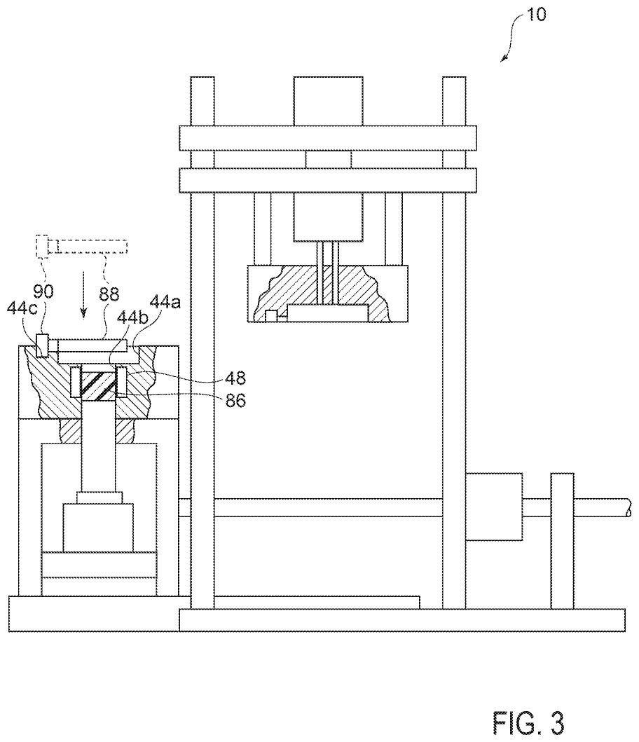

FIG. 3 shows an attachment step of an internal part 88 to the upper mold 42. First, a fixing member 90 is attached to the internal part 88 to be sealed in the product. In the exemplary embodiment, a pressure sensor is used as the fixing member 90. Additionally, other sensors or other electronic parts may be used as the fixing member 90. By sealing such electronic parts in the product, the electronic parts can be protected from external impact or blot etc., thereby significantly enhancing reliability of the electronic parts.

The internal part 88 has a contact portion which is exposed outside even when it is sealed in an inner portion of the product. Through this contact portion, electric power is supplied to the internal part 88 even after molding of the product, and data such as a detection result can be received from the internal part 88. The fixing member 90 fixes the internal part 88 to the fixing member 90 by holding this contact portion etc.

The fixing member 90 has a protruding part which has a shape corresponding to the fixing member supporting hole 44c of the lower mold 44. After the internal part 88 is fixed to the fixing member 90, the protruding part of the fixing member 90 is fitted to the fixing member supporting hole 44c of the lower mold 44, whereby the internal part 88 is fixed to the lower mold 44. In the exemplary embodiment, the operator fixes the internal part 88 to the fixing member 90, and further fixes the fixing member 90 to the lower mold 44. However, an attachment apparatus which automatically executes these operations may be used. Also, during the attachment step of the internal part 88 to the lower mold 44 through the fixing member 90, melting of the resin material 86 advances by the heater 48.

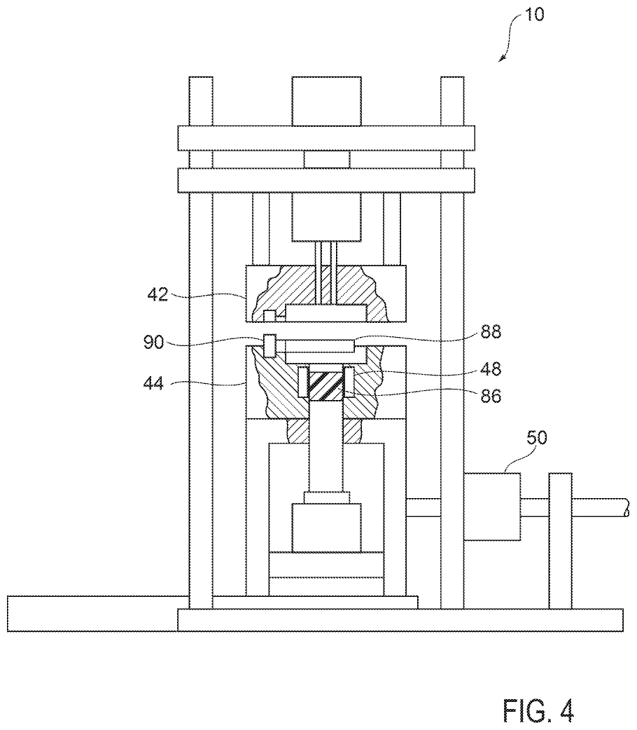

FIG. 4 shows the lower mold 44 which is moved to a portion below the upper mold 42 after insertion of the resin material 86 and an attachment of the internal part 88 to the lower mold 44. When the attachment of the internal part 88 to the lower mold 44 through the fixing member 90 is finished, the operator executes a command and an input to the control unit 24, whereby the control unit 24 operates the mold moving apparatus 50 to move the lower mold 44 in the horizontal direction to the portion below the upper mold 42. Additionally, if the attachment apparatus which automatically executes a step of fixing the internal part 88 to the lower mold 44 is used, the control unit 24 may automatically operate the mold moving apparatus 50 such that the lower mold 44 is moved to the portion below the upper mold 42 as shown in FIG. 4 even when the operator executes no command and input to the control unit 24.

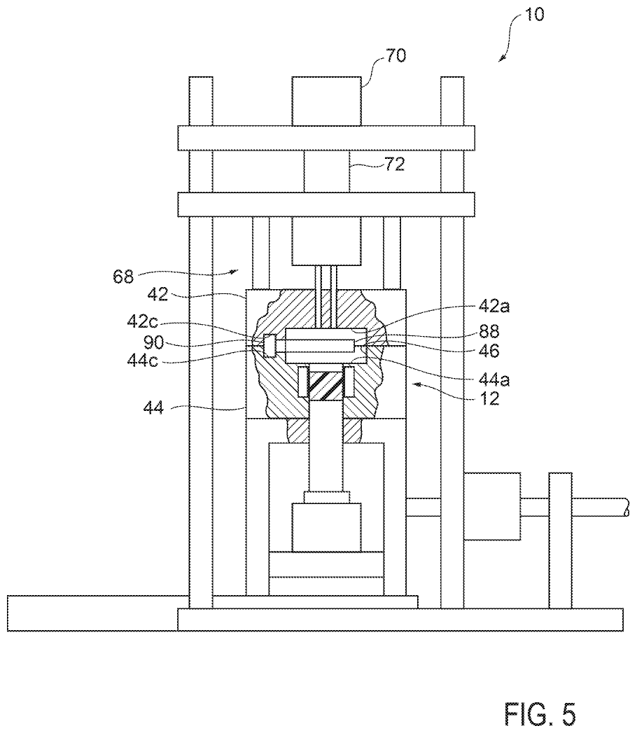

FIG. 5 is a drawing showing a closing step of the mold 12. When the lower mold 44 is moved to the portion below the upper mold 42, the control unit 24 operates the upper mold lifting apparatus 70 to lower the upper mold unit 68, and presses the upper mold 42 to the lower mold 44 to close the mold 12.

When the mold 12 is closed, the upper cavity 42a of the upper mold 42 and the lower cavity 44a of the lower mold 44 are combined, so that the cavity 46 is formed in an inner portion of the mold 12. A protruding part corresponding to the fixing member supporting hole 42c of the upper mold 42 is also provided to the fixing member 90. When the mold 12 is closed, the protruding part of the fixing member 90 is fitted to the fixing member supporting hole 42c of the upper mold 42. In this way, the fixing member 90 is firmly fixed to the mold 12 by the fixing member supporting hole 42c of the upper mold 42 and the fixing member supporting hole 44c of the lower mold 44, so that the internal part 88 is fixed in the cavity 46.

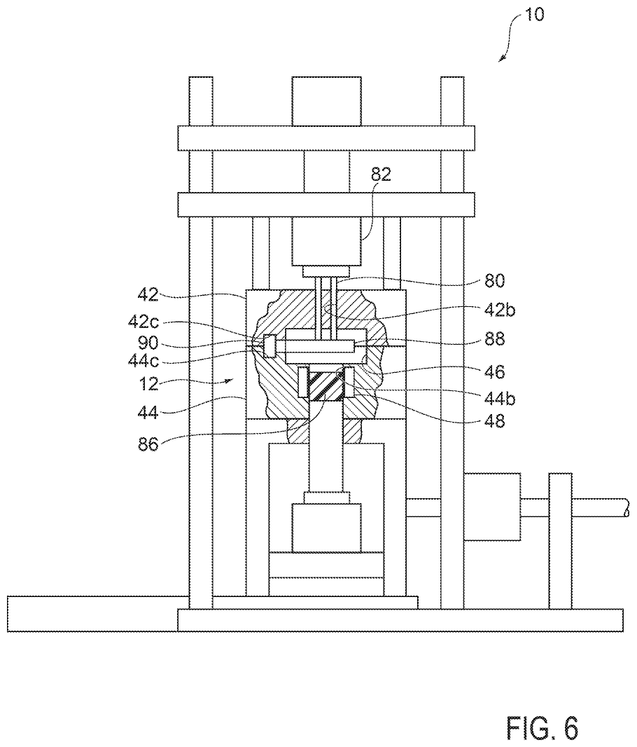

FIG. 6 is a drawing showing an advancing step of the supporting member 80. When the closing of the mold 12 is finished, the control unit 24 operates the supporting member driving apparatus 82 to press the supporting member 80 inserted in the insertion hole 42b until the supporting member 80 abuts on the internal part 88 fixed in the cavity 46. Since the internal part 88 is firmly fixed to the mold 12 through the fixing member 90, even when the supporting member 80 abuts on the internal part 88, the internal part 88 can maintain its position. At this time, the resin material 86 inserted in the cylinder hole 44b is heated by the heater 48 and completely melted.

As a result of earnest research and development by the inventors, it is found that the supporting member 80 is formed such that it abuts on at least both end portions of the internal part 88 in a width direction, that is, the both end portions of the internal part 88 in a perpendicular direction to the sheet surface of FIG. 6, whereby a positional variation of the supporting member 80 can be further inhibited.

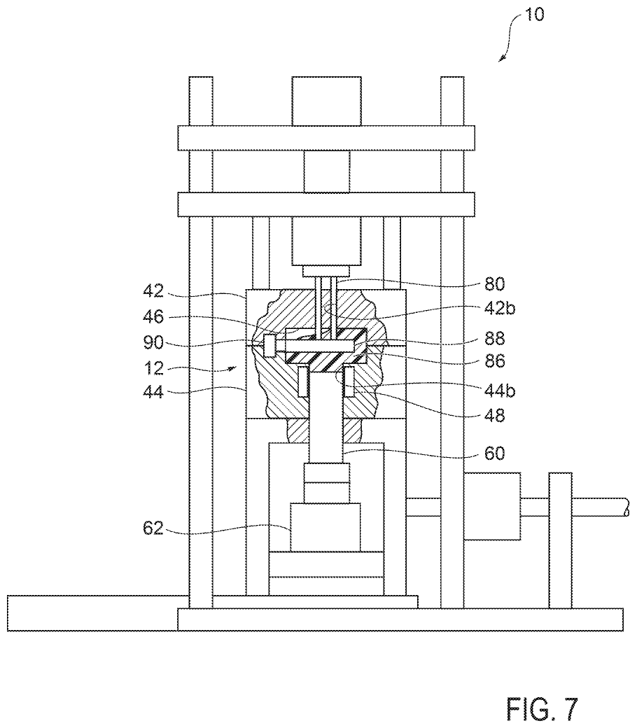

FIG. 7 is a drawing showing a first pressure step. When the advancing step of the supporting member 80 is finished, the control unit 24 operates the plunger driving apparatus 62 to advance the plunger 60 inserted in the cylinder hole 44b from the retracted position toward the cavity 46, and presses the resin material 86 inserted in the cylinder hole 44b in the cavity 46. At this time, the control unit 24 controls the pressure by the plunger driving apparatus 62 such that the resin material 86 is pressed in the cavity 46 with a primary pressure which is sufficient to spread the resin material 86 in the cavity 46. Due to this, the resin material 86 can also be spread across the internal part 88 seen from the plunger 60. In the exemplary embodiment, the resin material 86 is pressed in the cavity 46 with a pressure of 1 to 25 MP (megapascal) as the primary pressure. Additionally, the primary pressure is obviously not limited to this.

At this time, the internal part 88 abuts on the supporting member 80 in an opposite direction from the cylinder hole 44b and the plunger 60, which inhibits the positional variation caused by flowing of the resin material 86 extruded from the cylinder hole 44b by the plunger 60 into the cavity 46.

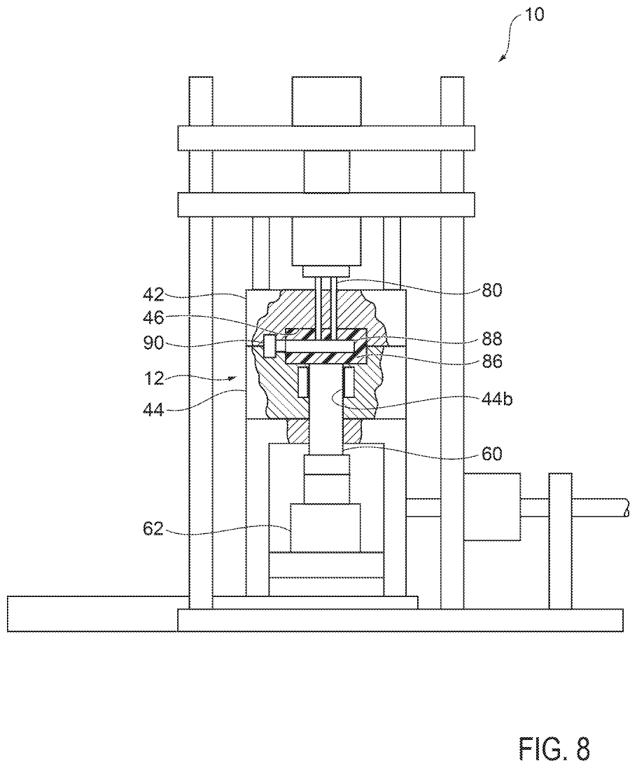

FIG. 8 shows a second pressure step. When a time which is sufficient to spread the resin material 86 in the cavity 46 is elapsed, the control unit 24 controls the pressure by the plunger driving apparatus 62 such that the resin material 86 is pressed in the cavity 46 with a secondary pressure which is higher than the primary pressure and sufficient to cure the resin material 86 in the cavity 46. Due to this, curing of the resin material 86 in the cavity 46 is promoted. In the present embodiment, the resin material 86 is pressed in the cavity 46 with a pressure of 25 to 27 MP (megapascal) as the secondary pressure. Additionally, the secondary pressure is obviously not limited to this. At this time, in addition to the matter that the internal part 88 is supported in the cavity 46 by the supporting member 80 and the fixing member 90, the resin material 86 has already spread to the entire cavity 46, so that a positional variation by the secondary pressure is inhibited.

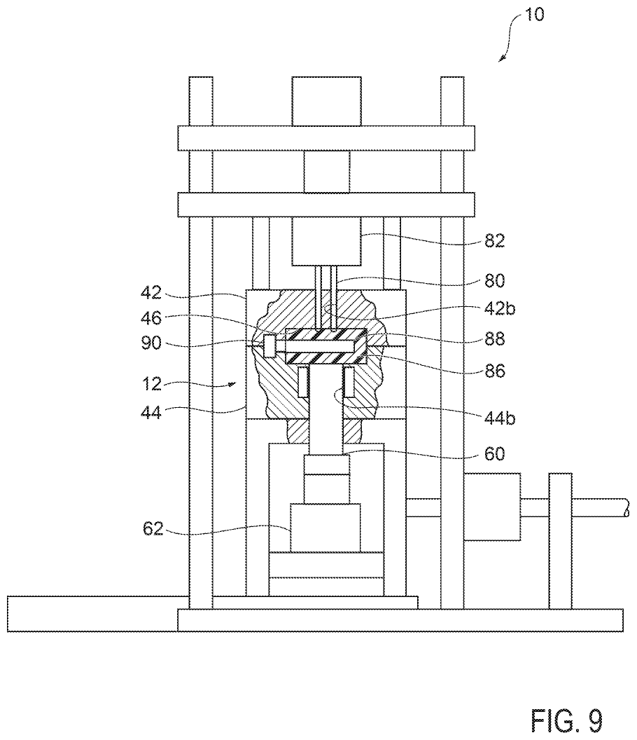

FIG. 9 is a drawing showing an extracting step of the supporting member 80. During the second pressure step, the control unit 24 operates the supporting member driving apparatus 82 to extract the supporting member 80 from the cavity 46. As a result of earnest research and development by the inventors, it is found that the positional variation of the internal part 88 can be extremely inhibited by extracting the supporting member 80 from the cavity 46 when the resin material 86 spreads to the entire inner portion of the cavity 46 and curing of the resin material 86 advances. Accordingly, it is found that the internal part 88 is directly sealed by the resin material 86 by extracting the supporting member 80 from the cavity 46 during the second pressure step.

Also, as a result of earnest research and development by the inventors, it is found that the resin material 86 is allowed to flow into a space where the internal part 88 had been for sealing by extracting the internal part 88 from the cavity 46 during the second pressure step while the resin material 86 is cured. Due to this, it is also found that influence on the product due to insertion of the supporting member 80 can be significantly reduced.

To further reduce the influence on the product by the supporting member 80, the control unit 24 stops the supporting member 80 at a position that a distal end surface of the supporting member 80 is flush with an inner surface of the cavity 46 to maintain that position.

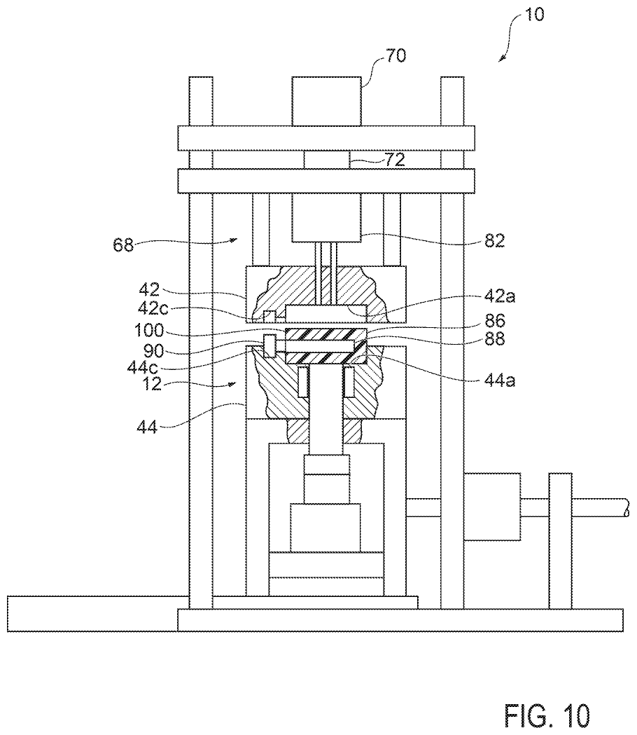

FIG. 10 shows an opening step of the mold 12 after molding of a product 100. When a time which is sufficient for curing of the resin material 86 is elapsed, the control unit 24 operates the upper mold lifting apparatus 70 to uplift the upper mold unit 68 to separate the upper mold 42 from the lower mold 44, and the mold 12 is opened. Due to this, the upper cavity 42a is separated from the product 100, and the protruding part at an upper side of the fixing member 90 is separated from the fixing member supporting hole 42c.

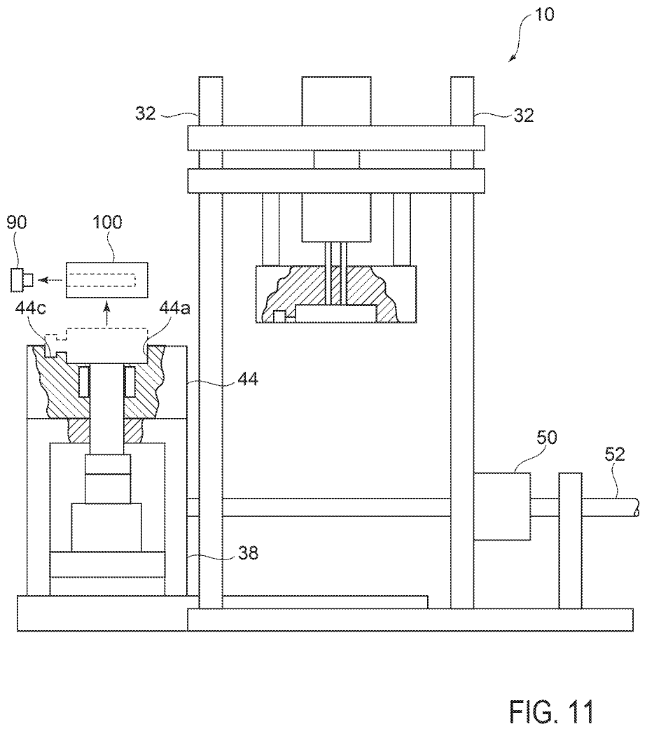

FIG. 11 shows a removing step of the product 100. After the opening of the mold 12, the control unit 24 operates the mold moving apparatus 50 to move the lower mold 44 again in the horizontal direction to the outside of the struts 32. By moving the lower mold 44 to this position, the product 100 can be easily removed.

At the same time that the product 100 is removed from the lower cavity 44a of the lower mold 44, the protruding part at a lower side of the fixing member 90 is removed from the fixing member supporting hole 44c of the lower mold 44, and further, the fixing member 90 is removed from the product 100, whereby the product 100 can be obtained.

FIG. 12A is a front view of the internal part 88, and FIG. 12B is a side view of the internal part 88. As described above, in the exemplary embodiment, the pressure sensor is used as the internal part 88. The internal part 88 is provided with the contact portion made of metal for power feeding and data transfer.

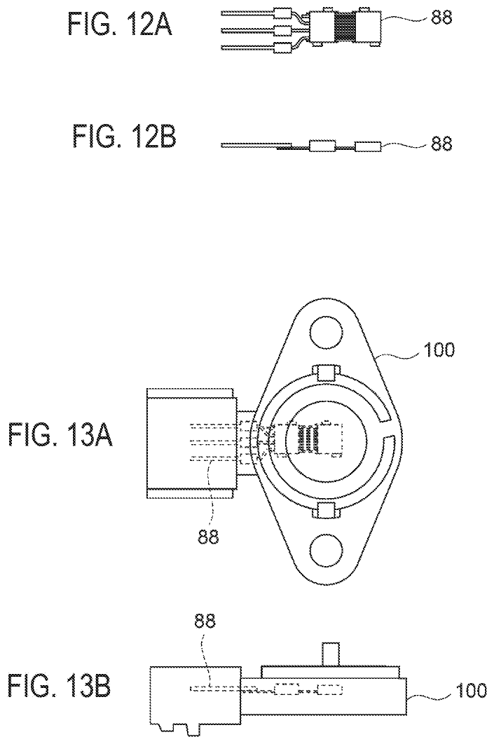

FIG. 13A is a front view of the product, and FIG. 13B is a side view of the product. In this way, according to the exemplary embodiment, the product 100 can be obtained by directly sealing the internal part 88 with a resin. Due to this, a manufacturing time of the product 100 is reduced, and a manufacturing cost can be inhibited.

As described above, while the present disclosure is explained with reference to the drawings, the present disclosure is not limited to the above embodiment, and an appropriate combination of the configurations of the embodiment or replacement of the configuration are included in the present disclosure. Also, appropriately changing the combination or order of the processes in the embodiment, and adding variations such as various design modifications to the embodiment based on knowledge of those skilled in the art can be executed, and the embodiment with such variation added can be included in the scope of the present disclosure.

What is claimed is:

1. A double compression molding machine comprising:
a plunger;
a supporting member configured to support an internal part to be sealed in an inner portion of a product to be molded;
a mold having a cavity in which the product is molded,
a cylinder hole which communicates with the cavity and into which the plunger is inserted,
an insertion hole which communicates with the cavity and into which the supporting member is inserted and a fixing member which fixes the internal part in the cavity;
a plunger driving apparatus configured to press a resin material inserted in the cylinder hole into the cavity such that the product is molded when the plunger is at a retracted position by advancing the plunger inserted in the cylinder hole from the retracted position toward the cavity; and
a supporting member driving apparatus configured to press the supporting member inserted in the insertion hole until the supporting member abuts on the internal part fixed in the cavity and extracts the supporting member inserted in the insertion hole from the cavity.

2. The double compression molding machine according to claim 1, further comprising:
a heating apparatus which heats the resin material inserted in the cylinder hole.

3. A method for manufacturing a product, the comprising:
inserting a resin material in a cylinder hole when a plunger which is inserted is at a retracted position;
fixing an internal part to be sealed in an inner portion of the product to be molded in a cavity of a mold where the product is to be molded;
pressing a supporting member inserted in an insertion hole, the insertion hole communicating with the cavity, until the supporting member abuts on the internal part fixed in the cavity by a supporting member driving apparatus; and
pressing the resin material inserted in the cylinder hole in the cavity such that the product is molded by advancing the plunger inserted in the cylinder hole, the cylinder hole communicating with the cavity, from the retracted position toward the cavity, wherein upon the pressing of the resin material in the cavity, the supporting member is extracted from the cavity.

4. The method according to claim 3, wherein the pressing of the resin material in the cavity comprises:
a first pressure step of pressing the resin material in the cavity with a primary pressure; and
a second pressure step of pressing the resin material in the cavity with a secondary pressure which is higher than the primary pressure, and
wherein in the second pressure step, the supporting member is extracted from the cavity.
